(19) United States
(12) Patent Application Publication
(10) Pub. No.: US 2005/0289280 A1
(43) Pub. Date: Dec. 29, 2005

(54) Switching fabric bridge

(75) Inventor: Jeff Hopkins, Orrington, ME (US)

Correspondence Address: STEUBING AND MCGUINESS & MANARAS LLP, 125 NAGOG PARK, ACTON, MA, 01720, US

(73) Assignee: Tundra Semiconductor Corporation

(21) Appl. No.: 11/146,725

(22) Filed: Jun. 7, 2005

Related U.S. Application Data
(60) Provisional application No. 60/582,350, filed on Jun. 23, 2004.

(51) Int. Cl. G06F 13/36

(52) U.S. Cl. 710/316; 710/310

(57) ABSTRACT

A non-blocking switch fabric for bridging peripheral component interconnect extended busses includes a switching matrix and a plurality of ports coupled to the switching matrix. Each port has an incoming queue, an outgoing queue, a first module for generating a packet, the packet including one of a left-aligned command and right-aligned fabric command. The first module coupled to the outgoing queue. A second module for receiving a packet is coupled to the incoming queue. In dependence upon the fabric command the incoming queue receives the data as one of left-aligned data and right-aligned data. Each port also includes a third module for monitoring the incoming queue and storing buffer releases in dependence upon a first queue occupation threshold and releasing stored buffer releases in dependence upon a second queue occupation threshold, the first queue occupation threshold being higher than the second.

### RELATED APPLICATIONS

This application claims priority under 35 U.S.C. §1.119(e) to provisional application Ser. No. 60/582,350, filed on Jun. 23, 2004 entitled “Switching Fabric Bridge.”

### FIELD OF THE INVENTION

The present invention relates to switch fabric bridges and is particularly concerned with bridging peripheral component interconnect extended (PCI-X) busses in conjunction with other dissimilar busses.

### BACKGROUND OF THE INVENTION

Traditional computer component communications have been achieved by the use of shared busses, either multi-drop, like PCI or multiplexed, like AMBA. In a multi-drop bus, as shown in FIG. 1, all devices are connected to a central set of wires or a bus. When a communication is required, a sending device 14 takes control of the bus and sends its information to the receiving device 16, which is listening to the bus. After the communication is completed the bus is released for the next use by another device. The same function is accomplished with a multiplexed bus except a central arbiter switches a set of multiplexers to create the point to point connection.

In a multi-drop bus, as shown in FIG. 1, all devices are connected to a central set of wires or a bus. When a communication is required, a sending device 14 takes control of the bus and sends its information to the receiving device 16, which is listening to the bus. After the communication is completed the bus is released for the next use by another device.

As the speed and complexity of the electronic devices has increased a need for faster and more efficient data communications has evolved. A major problem with the bus structures described above is that data communication transactions are completed serially or one at a time. A transaction between one sender, to one receiver must wait until all the transactions that are ahead of it in line have completed, even though they may have no relation to the first transaction in question. If a sender of a transaction is ready, but the receiver is not ready, the current transaction can block the completion of subsequent transactions. Both PCI and AMBA have ordering rules, which allow some transactions to pass the current transaction but there is no distinction as to the transaction receiver. If Receiver B is not ready but Receiver C is ready, sender A must still wait to complete the transaction to Receiver B before it attempts the transaction to Receiver C.

Referring to FIG. 2, there is illustrated an example of a known non-blocking switching fabric. Non-blocking switch fabrics, like RapidIO at the board or back plane level and OCN at the on chip level, help to alleviate the basic inefficiencies found in the standard multi-drop busses like PCI/PCIX. Within a switch fabric, each transaction that would normally occur on the multi-drop bus defines a packet within the fabric. The size of the packets is specific to the fabric in question.

These packets traverse the fabric from a source port to a destination port. The flow of packets is controlled by a priority assigned to each packet. Packets, whose destination ports are the same, are processed by their priority assignments, with higher priority packets passing lower priority packets. Packets within the same priority level are processed in the order they are received. Within these fabrics there is no defined relationship between the type of packet (read, write, response, message) and its priority. However, it is usually suggested that responses are always sent at a priority level one higher that the requesting packet, to avoid deadlock conditions.

A transaction is received at the sender and stored or buffered in the fabric. Some time later, the data is presented at the receiver. During the transmission across the fabric, the data within a packet is stored at various locations within the fabric. Ordering is maintained in the fabric only as it relates to one sender and one receiver. For the example above, when applied to a switch fabric 20, Sender A (14) sends a packet to Receiver B (16), which in turn sends a packet to Receiver C (18). While Receiver B is busy, the packet is stored in the fabric 20. In the meantime, Receiver C is ready to receive its packet and that transaction completes because the packet to Receiver C is not blocked by the A to B transaction.

The non-blocking switch fabric 20 provides a significant performance improvement to the standard multi-drop bus 10. Data flow between different ports is not blocked, and it may also be concurrent when different senders are communicating to different receivers.

Endianess is a method of “packing” of small data fields into a larger fabric structure for transmission or analysis. For example FIG. 3 illustrates a little-endian system. In a little-endian system, the received values in the sequence are stored in what is traditionally identified as the right to left of the larger structure. For example, consider the four bytes 0 1 2 3 stored in an eight byte wide structure as shown in FIG. 3. While FIG. 4 illustrates the same four bytes, stored in an eight byte big-endian system. In a big-endian system, the bytes in the sequence are stored in the traditional left to right direction. Endian packing does not only apply only to byte sized structures. It applies to any structure that is smaller than the fabric structure into which it is being packed.

Endianess is a particularly problematic issue for data communications. This packing method is normally not a problem for data communication fabrics because the fabric makes no determination as to the data encapsulated in the larger fabric structure. An address, and a block of data are sent across the fabric, to be interpreted by the endpoint without regard to the endianess.

Clearly when systems with different endian needs like PowerPC (big endian) and PCI (little endian) are connected to the same fabric there are always problems with data consistency. Usually these problems are left to the individual ports to resolve.

However, even with endian neutral fabrics, a problem arises when a packet transmits data that is not aligned to natural boundaries of the fabric (as shown in FIGS. 3 and 4). That is, if a fabric datum is eight bytes wide and a packet address starts at address four (4), then the first four (4) of the first datum's bytes will not be valid. The problem is, which four, the left four or the right four?

Switch fabrics such as RapidIO or OCN handle this problem by forcing the port to send a single non-aligned packet as two or more packets, one for the first data phase, one for the aligned section, and possibly one for the last data phase. This approach may cause problems because the separate packets may be split up in transfer and other packets from other ports, which cause the access the same information, may be corrupted by reading information from an inconsistent location.

Another solution to this problem has been addressed in PCI by reversing all the bytes within a big endian packet, that is, converting it to what looks like a little endian packet, sending the converted packet, then at the receiving port reversing all the bytes again. This approach could cause problems when the size of the sub-field is not byte based. If the bytes of a larger data field are reversed the data is corrupted. This forces the receiving port to un-reverse the bytes in order to use the information. However, this approach forces the destination port to know where a certain packet came from and whether to reverse the bytes or not. For a large fabric this solution becomes very cumbersome.

Another problem with routing PCI across a priority based fabric is that PCI has no specific priority structure related to its transactions. All transactions are dealt with at the same priority. PCI does, however, have strict transaction ordering rules. Within PCI there are three types of transactions, requests, posted writes, and completions. PCI ordering rules allow (require the possibility of) posted writes to pass all other transactions and completions to pass all requests. If a priority based fabric uses priorities to enforce PCI ordering rules it assigns a lower priority to requests, a medium priority to completions and a high priority to Posted writes. This enforces proper PCI ordering. However, this can give rise to a problem when this type of fabric becomes backed up. When the fabric is full, the higher priority packets tend to use up all the fabric capacity and the lower priority requests never get through. This is called packet starvation. One method of dealing with this problem is to hold up transmission of higher priority packets at the source port every so often to allow lower priority packets to progress through the fabric. While this approach works, it adds latency (time to complete) to some of the transactions that have been held up, which then must pass through the fabric after the lower priority packet has cleared. Another solution is to significantly increase the complexity of the fabric to guarantee that all packets are transferred with some regularity. While this is a good solution, it is not always possible to change the architecture of the fabric to accommodate implementation.

### SUMMARY OF THE INVENTION

An object of the present invention is to provide an improved a non-blocking switch fabric for bridging peripheral component interconnect extended busses with other diverse busses.

In accordance with an aspect of the present invention there is provided a non-blocking switch fabric for bridging peripheral component interconnect extended busses comprising: a switching matrix; and a plurality of ports coupled to the switching matrix; each port having an incoming queue, an outgoing queue, means for generating a packet, the packet including one of a left-aligned command or right-aligned fabric command, coupled to the outgoing queue and means for receiving a packet, coupled to the incoming queue and in dependence upon the fabric command receiving the data as one of left-aligned data and right-aligned data.

In accordance with another aspect of the present invention there is provided a method of transferring data via a non-blocking switch fabric for bridging peripheral component interconnect extended busses comprising the steps of: providing a switch fabric with commands for left aligned and right aligned data; generating a packet at a first port, the packet including one of a left-aligned command or right-aligned fabric command; receiving the packet at a second port and in dependence upon the fabric command receiving the data as one of left-aligned data and right-aligned data.

In accordance with a further aspect of the present invention there is provided a non-blocking switch fabric for bridging peripheral component interconnect extended busses comprising: a switching matrix; and a plurality of ports coupled to the switching matrix; each port having an incoming queue, an outgoing queue, and means for monitoring the incoming queue and storing buffer releases in dependence upon a first queue occupation threshold and releasing stored buffer releases in dependence upon a second queue occupation threshold, the first queue occupation threshold being higher than the second.

In accordance with another aspect of the present invention there is provided a method of transferring data via a non-blocking switch fabric for bridging peripheral component interconnect extended busses comprising the steps of: for each destination port couple to a switch fabric, monitoring each incoming queue and storing buffer releases in dependence upon a first queue occupation threshold; and releasing stored buffer releases in dependence upon a second queue occupation threshold, the first queue occupation threshold being higher than the second.

### BRIEF DESCRIPTION OF THE DRAWINGS

The present invention will be further understood from the following detailed description with reference to the drawings in which:

FIG. 1 illustrates a known multi-drop bus;

FIG. 2 illustrates a known non-blocking switch fabric;

FIG. 3 illustrates data stored in a little endian system;

FIG. 4 illustrates data stored in a big endian system;

FIG. 5 illustrates an enhanced OCN fabric in accordance with an embodiment of the present invention;

FIG. 6 illustrates an enhanced OCN request header in accordance with an embodiment of the present invention;

FIG. 7 illustrates an enhanced OCN response header/data in accordance with an embodiment of the present invention;

FIG. 8 illustrates an enhanced OCN response header with no data in accordance with an embodiment of the present invention;

FIG. 9 illustrates in a block diagram a switching fabric bridge with a thermometer circuit in accordance with a further embodiment of the present invention;

FIG. 10 illustrates the OCN fabric receive layer of FIG. 5 for left aligned data; and

FIG. 11 illustrates the OCN fabric receive layer of FIG. 5 for right aligned data.

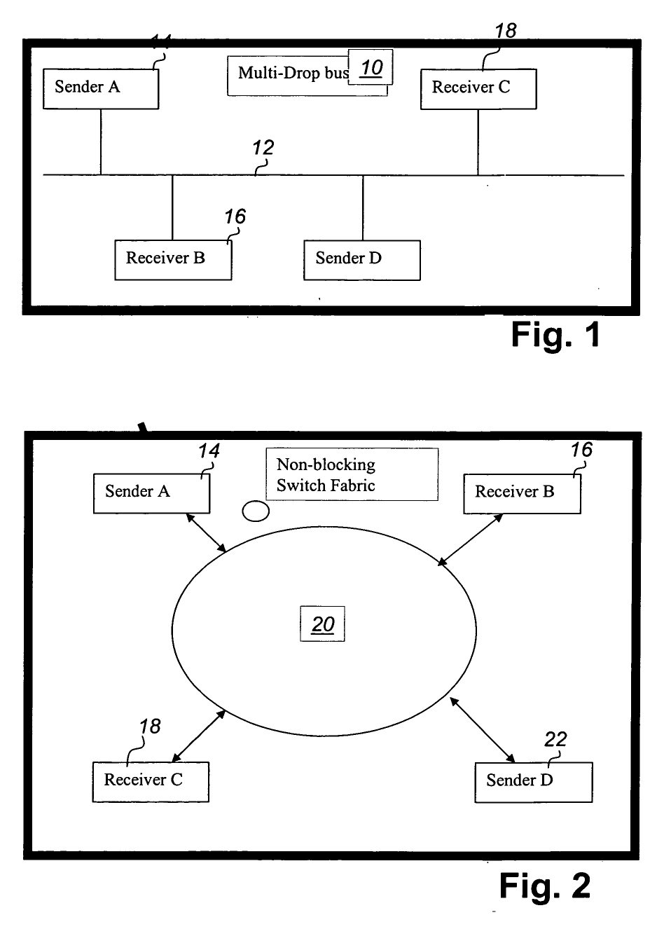

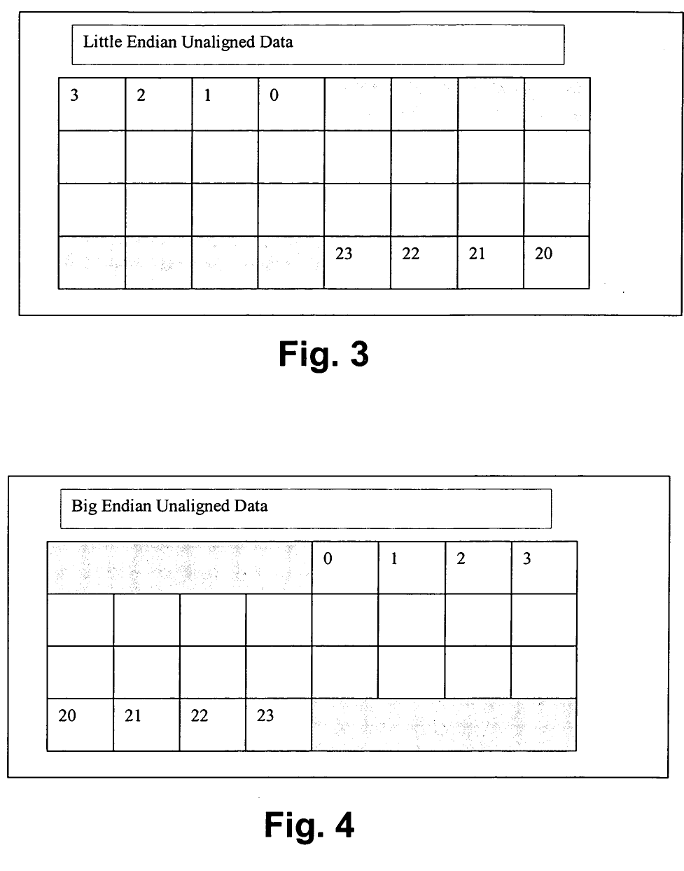

### DETAILED DESCRIPTION OF THE PREFERRED EMBODIMENT

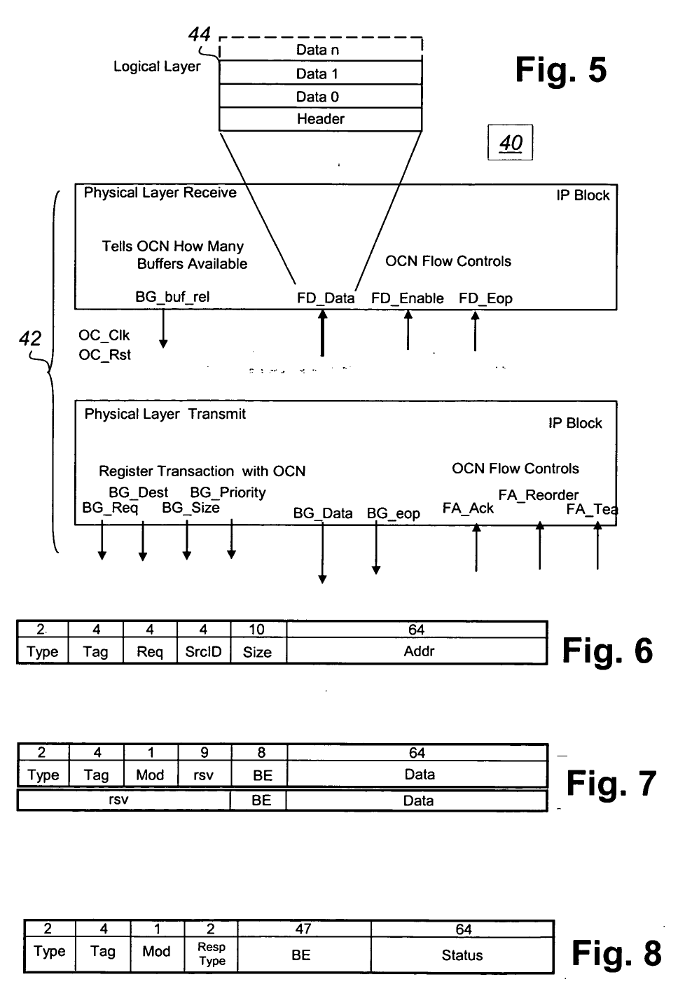

Referring to FIG. 5 there is illustrated an enhanced OCN fabric in accordance with an embodiment of the present invention. An embodiment of the present invention is described in further detail in the context the enhanced OCN fabric. The enhanced OCN fabric 40 has a physical layer 42 has a data path widened to 88 bits from 70 bits. The logical layer 44 is 88 bits. The logical layer is PCIX centric: Byte enables are carried with each data phase; and the command field is a PCIX command. The address is a byte address and the count or size is a byte count or byte enables for a single data phase read. Unaligned block transfers are handled with a combination of address and size. A new PCIX specific type of packet has been added to pass PCIX attribute information. This is used only when communicating between PCI blocks.

Referring to FIG. 6 there is illustrated an enhanced OCN request header in accordance with an embodiment of the present invention.

Referring to FIG. 7 there is illustrated an enhanced OCN response header/data in accordance with an embodiment of the present invention.

Referring to FIG. 8 there is illustrated an enhanced OCN response header with no data in accordance with an embodiment of the present invention.

To solve the endian issues for new fabrics or to provide an upgrade to an existing fabric like the enhanced OCN fabric of FIG. 5, in accordance with an embodiment of the present invention, each fabric command is provided with two versions, a left aligned version and a right aligned version.

In operation, all little endian type ports send packets with the left aligned command version and all big endian type ports send packets with right aligned command version. This allows the destination port to receive an unaligned data packet in a contiguous packet and handle it appropriately.

Typically, as a transaction is processed at the destination port, the buffer it used is freed and the fabric is notified that another buffer location is available. As the buffers become available more packets are sent to the destination port. When a destination port cannot process the packets quickly enough it gets backed up and does not allow further packets to be sent through the fabric. If the incoming buffers are pictured as a digital thermometer, all the slots would be full and no more packets can be received. In a priority-based fabric, higher priority packets must be allowed to pass lower priority packets. In order for this to happen when incoming buffers are almost full only high priority packets can be allowed to progress and use the last buffers. In the case of the backed up fabric, if the fabric is full and one buffer is released, it is only free to receive the highest priority packet. If there is a highest priority packets waiting, as soon as the buffer is released, this packet is allowed to pass lower priority packets. This causes the starvation.

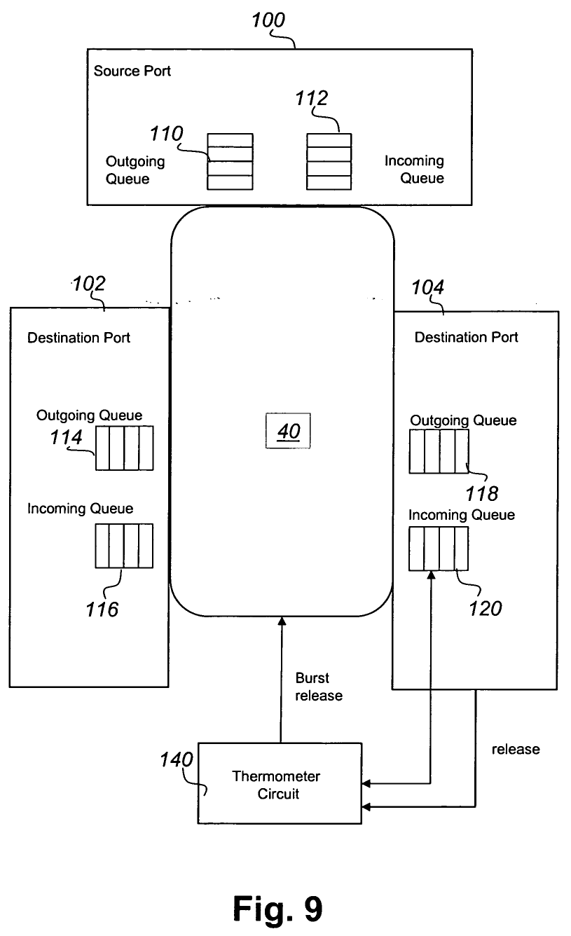

Referring to FIG. 9 there is illustrated in a block diagram a switching fabric bridge with a thermometer circuit coupled thereto in accordance with a further embodiment of the present invention. FIG. 9 illustrates an embodiment of the thermometer circuit implemented on the enhanced OCN fabric of FIG. 5. In FIG. 5, ports 100, 102 and 104 are interconnected via the enhanced OCN switch fabric of FIG. 5. Ports 100, 102 and 104 have outgoing and incoming queues 110 and 112; 114 and 116; and 118 and 120, respectively. To solve the starvation problem in accordance with an embodiment of the present invention a thermometer circuit 140 is added to destination port 104. Destination port 104 has a certain number of buffers to hold incoming transactions (incoming queue 120).

In operation, the thermometer circuit 140 watches the buffer allocation. When the thermometer circuit 140 detects that there is a backup, and there are higher priority packets, waiting in the incoming queue to be processed, which would be required to finish before processing any incoming higher priority packets, buffer releases are stored rather than immediately sent to the fabric. When there are one or two packets left to be processed, all stored buffers are released at once. The first free buffer accepts the highest priority packet, but while the packet is being transferred the addition buffers become available. This makes the port appear to not be backed up, and packets of any priority are accepted after the first packet is received. Since the packets that are coming to the port are already in the fabric, there is no added latency caused by this solution. The thermometer circuit 140 can be thought of as a temperature, or fuel gauge that rises and falls until it crosses a threshold. It then waits for a while i.e. cools down, before opening the flow of more data. It exists solely in the port so it does not affect the fabric functionality.

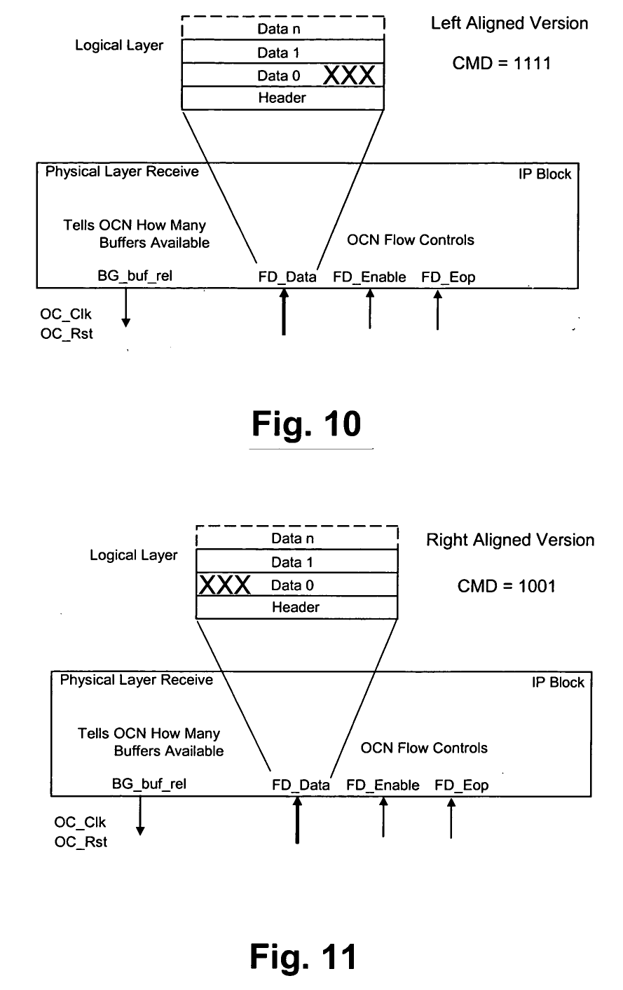

Referring to FIG. 10 there is illustrated the OCN fabric receive layer of FIG. 5 for left aligned data. The left-aligned command is CMD=1111.

Referring to FIG. 11 there is illustrated the OCN fabric receive layer of FIG. 5 for right aligned data. The right-aligned command is CMD=1001.

Having described an exemplary embodiment of the present invention, it will be appreciated that various modifications may be made without diverging from the spirit and scope of the invention. The above description has talked of the present invention in terms of functional blocks delineated in a manner to facilitate description. However, it should be noted that the invention may be implemented in a variety of arrangements, using hardware, software or a combination thereof, and the present invention is not limited to the disclosed embodiment. It will be understood that each block of any flowchart illustrations, and combinations of blocks in the flowchart illustrations, can be implemented by computer program instructions. These computer program instructions may be loaded onto a computer or other programmable data processing apparatus to produce a machine, such that the instructions which execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

1. A non-blocking switch fabric for bridging peripheral component interconnect extended busses comprising:
a switching matrix; and
a plurality of ports coupled to the switching matrix;
each port having an incoming queue, an outgoing queue, means for generating a packet, the packet including one of a left-aligned command and right-aligned fabric command, coupled to the outgoing queue and means for receiving a packet, coupled to the incoming queue and in dependence upon the fabric command receiving the data as one of left-aligned data and right-aligned data.

2. A non-blocking switch fabric as claimed in claim 1 wherein the switching matrix is an enhanced OCN fabric.

3. A non-blocking switch fabric as claimed in claim 1 wherein the switching matrix has a logical layer that is PCI-X compatible.

4. A method of transferring data via a non-blocking switch fabric for bridging peripheral component interconnect extended busses comprising the steps of:
providing a switch fabric with commands for left aligned and right aligned data;
generating a packet at a first port, the packet including one of a left-aligned command and right-aligned fabric command;
receiving the packet at a second port and in dependence upon the fabric command receiving the data as one of left-aligned data and right-aligned data.

5. A method as claimed in claim 4, wherein the switching matrix is an enhanced OCN fabric.

6. A method as claimed in claim 4, wherein the switching matrix has a logical layer that is PCI-X compatible.

7. A non-blocking switch fabric for bridging peripheral component interconnect extended busses comprising:
a switching matrix; and
a plurality of ports coupled to the switching matrix;
each port having an incoming queue, an outgoing queue, and means for monitoring the incoming queue and storing buffer releases in dependence upon a first queue occupation threshold and releasing stored buffer releases in dependence upon a second queue occupation threshold, the first queue occupation threshold being higher than the second.

8. A non-blocking switch fabric as claimed in claim 7 wherein the switching matrix is an enhanced OCN fabric.

9. A non-blocking switch fabric as claimed in claim 7 wherein the switching matrix has a logical layer that is PCI-X compatible.

10. A method of transferring data via a non-blocking switch fabric for bridging peripheral component interconnect extended busses comprising the steps of:
for each destination port couple to a switch fabric, monitoring each incoming queue and storing buffer releases in dependence upon a first queue occupation threshold; and
releasing stored buffer releases in dependence upon a second queue occupation threshold, the first queue occupation threshold being higher than the second.

11. A method as claimed in claim 10, wherein the switching matrix is an enhanced OCN fabric.

12. A method as claimed in claim 10, wherein the switching matrix has a logical layer that is PCI-X compatible.
